(19) United States
(12) Patent Application Publication
(10) Pub. No.: US 2003/0090569 A1
(43) Pub. Date: May 15, 2003

(54) Camera and brake system warning light configured as an integrated unit

(76) Inventor: Werner Poechmueller, Hildesheim (DE)

Correspondence Address: KENYON & KENYON, ONE BROADWAY, NEW YORK, NY, 10004, US

(21) Appl. No.: 10/220,391

(22) PCT Filed: Mar. 5, 2001
(86) PCT No.: PCT/DE01/00816

(30) Foreign Application Priority Data
Mar. 3, 2000 (DE) 100 10 434.7

(51) Int. Cl. H04N 7/18

(52) U.S. Cl. 348/148; 382/104

(57) ABSTRACT

A camera device is proposed in a third brake light in a motor vehicle, which functions to monitor the rear driving space, it being possible to, on the one hand, improve the monitoring of the rear driving space and, on the other hand, to permit a simple assembly of a camera device, as a result of the arrangement in the third brake light.

### BACKGROUND INFORMATION

The present invention starts out from a camera device according to the species of the main claim. For monitoring the rear driving space, ultrasound sensors are already known, which are arranged on a rear bumper of a vehicle and which make it possible to measure the distance to obstacles. However, in this manner only distance values can be signaled to the user. In addition, to make it easier to attach a trailer, it is known to arrange a camera on the end of a trailer of a truck or a semi, so as to provide to the driver an image for attaching the trailer. It is also known in passenger cars to integrate cameras in the vicinity of the bumper, so as to be similar to the positions of ultrasound sensors.

### ADVANTAGES OF THE INVENTION

In contrast, the camera device according to the present invention having the features of the main claim has the advantage that the camera device, because of its arrangement on the third brake light, is arranged significantly higher on the vehicle than a camera that is situated at the level of a bumper. Because of the greater height, the camera has a larger viewing angle. As a result, obstacles that are more distant can already be detected by the camera, in contrast to an arrangement that is located in the area of the bumper. A position on the rear window is especially advantageous in vehicles in which the rear window represents approximately the end of the vehicle, and no trunk is disposed between the rear window and the end of the vehicle, e.g., in so-called vans or so-called combi vehicles that have a storage area that is larger than that of a sedan.

It should be seen as a further advantage that the camera can be arranged on the third brake light so as to be very inconspicuous. It is also advantageous that the camera device is installed along with the installation of the third brake light, which is a mandatory component in many countries, without thereby requiring an additional step for installing the camera device.

As a result of the measures indicated in the subclaims, advantageous refinements and improvements of the camera device indicated in main claim are possible. It is especially advantageous to provide the camera device, along with the third brake light, in one area on the rear window of the vehicle and to arrange a windshield wiper on the vehicle at least for this area of the rear window, it being possible to clean the rear window in the vicinity of the camera using the windshield wiper. In this manner, it is avoided that a representation of the rear driving space in a display is impaired or prevented as a result of dirt accumulating in front of the lens of the camera device. If the image quality should decrease, the windshield wiper can be triggered, preferably automatically, to clean the windshield in front of the camera lens. This can be accomplished using a sensor, which measures the reflection of the brake light on the window and, in response to a too powerful reflection, infers the presence of dirt and triggers the windshield wiper. In addition, by analyzing the received image as to whether interferences are present, an automatic actuation of the windshield wiper can be triggered.

It is especially advantageous, in addition to actuating the windshield wiper, to also trigger spray nozzles arranged on the rear window, which apply a cleaning fluid to the window that moistens and cleans the windshield. In this context, it is especially advantageous to arrange the cleaning nozzle so that primarily the area in front of the camera is wetted by the cleaning fluid especially well, so that an especially effective cleaning can be achieved in this area. In particular, it is advantageous, when the reverse gear is engaged, to automatically trigger a cleaning of the windshield, especially in the area of the camera device. Furthermore, a cleaning in response to activating the camera device can also be triggered by the driver, e.g., if the driver wishes to initiate a reverse parking procedure. It is especially advantageous, through the use of a time-controlled squelch circuit, to prevent multiple cleanings within short time intervals by the windshield wiper and/or the application of cleaning fluid.

Furthermore, it is advantageous to provide a common voltage supply for the camera device and brake light, so as to economize on the electrical lines to be laid, e.g., through the vehicle roof In this context, it is especially advantageous that the illumination means that are customary for the third brake light, e.g., LEDs and camera devices, require for their operation an electrical voltage that lies below the usual system voltages of vehicles. Transforming the voltage to a value within a preferred range of 4 to 8 V can therefore be carried out in common for the brake light and the camera device preferably outside a housing of the brake light.

It is also advantageous that, as a result of an arrangement of two camera devices, recorded image signals can be evaluated stereoscopically and, as a result, distances to individual obstacles during reverse driving can be overlaid in one display for a user.

It is also advantageous to arrange the camera device and the brake light in one housing, because, as a result, a less conspicuous and more attractive design is possible compared to an arrangement of the camera device as a separate component. It is also especially advantageous to arrange a windshield wiper and/or spray nozzle on the housing, because, as a result, on the one hand, the installation of the parts in question can take place in one working step and, on the other hand, there is an optimal positioning of the cleaning devices, even in a retrofitted installation.

### DRAWING

Exemplary embodiments of the present invention are depicted in the drawing and are discussed in greater detail in the description below.

FIG. 1 depicts a view of a rear side of a vehicle having a camera device according to the present invention on a third brake light,

FIG. 2 depicts a view of a rear window of a vehicle having two further designs of a camera device according to the present invention,

FIGS. 3a, 3b, and 3c depict embodiments according to the present invention of one or a plurality of camera devices on a brake light,

FIG. 4 depicts a cutaway view of a brake light in a side view along with a camera device according to the present invention,

FIG. 5 depicts a cutaway view of the brake light in a top view, and

FIG. 6 depicts a block diagram for a camera device according to the present invention and a brake light.

### DESCRIPTION OF THE EXEMPLARY EMBODIMENT

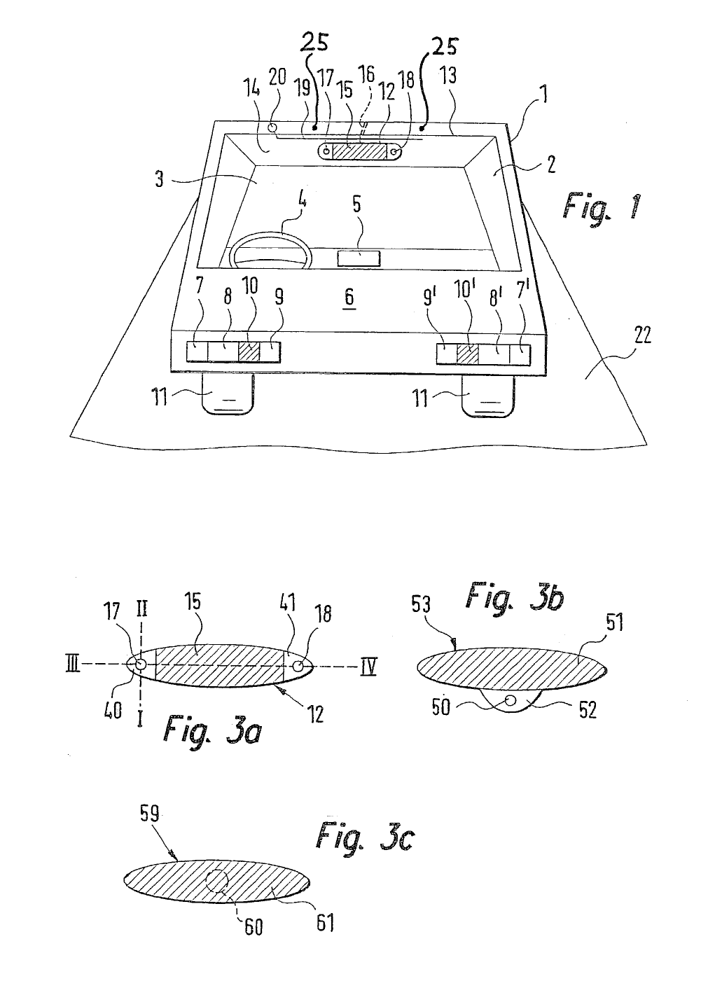

The camera device according to the present invention can be used for a multiplicity of vehicles, e.g., trucks, rail vehicles, or buses. The exemplary embodiment is discussed on the basis of an application in a passenger car. Depicted in FIG. 1 is a motor vehicle 1 in a rear view. Visible through a rear window 2 is a windshield 3, a steering wheel 4, and a display unit 5. Rear window 2 is arranged in a tailgate 6 of motor vehicle 1. Located below tailgate 6 is the rear vehicle lighting having two turn signals 7, 7′, tail lights 8,8′, backup lights 9,9′, and brake lights 10, 10′. The vehicle lights are arranged in mirror symmetry on both sides of the vehicle, left and right. Motor vehicle 1 is elevated on tires 11 over a roadway 22, on which the vehicle moves and which therefore represents the drive path of the vehicle. Third brake light 12, in this context, is a greater distance from roadway 22 than first and second brake lights 10, 10′. Third brake light 12 is arranged on an upper edge 13 of rear window 2. Upper edge 13 adjoins a vehicle roof 14. Third brake light 12 has a luminous surface 15, which, in response to the actuation of the vehicle brakes, not depicted in FIG. 1, lights up, just as do first and second brake lights 10, 10′. Third brake light 12 is connected to lines 16 leading to the current supply, which are run from vehicle roof 14 to third brake light 12. Arranged on, third brake light 12 are, on a first side, a first camera 17 and, on a second side, a second camera 18. Arranged on rear window 2 is a windshield wiper 19, which is mounted on a holding device 20. Using windshield wiper 19, rear window 2 can be cleaned in front of first camera 17 and second camera 18. Arranged in the area of upper edge 13 of rear window 2 in the vicinity of first and second camera device 17, 18 are spray nozzles 25, which can apply a cleaning fluid to rear window 2. In response to a motion of windshield wiper 19, the cleaning fluid is distributed over rear window 2, so that rear window 2 is wetted by cleaning fluid and, in the process, is cleaned mechanically by windshield wiper 19.

The rear driving space behind motor vehicle 1 can be monitored by first camera 17 and second camera 18, which are arranged behind rear window 2. Via lines 16, the detected image signals are conveyed to an evaluation unit that is not depicted in FIG. 1, which is arranged advantageously in a dashboard of motor vehicle 1, and they are displayed in display unit 5 for a driver and/or for a passenger in the motor vehicle. If the image quality should degenerate as a result of the soiling of rear window 2, then windshield wiper 19 can automatically be activated and can clean rear window 2 in front of first camera 17 and second camera 18. In addition to the automatic actuation of windshield wiper 19, spray nozzles 25 can automatically supply cleaning fluid to rear window 2. The cleaning fluid is supplied to the spray nozzles preferably via supply lines that run parallel to lines 16 along the vehicle roof from a reservoir in the area of the trunk or of the engine compartment of the vehicle. The cleaning fluid can contain, e.g., alcohol, so that any icing that may build up on the rear window can be removed by applying the cleaning fluid. Before being applied on rear window 2, the cleaning fluid is advantageously heated by heating devices that are arranged on the spray nozzles and that are not depicted in the drawing. Soiling can be detected, on the one hand, by a sensor that is arranged in or on brake light 12, it being possible, using the sensor, to determine, e.g., the transparency of the rear window. It is also possible to automatically actuate windshield wiper 19 and/or spray nozzles 25, e.g., on the basis of an evaluation of the image detected by the camera device, if it is no longer possible to detect any structures in the transmitted image, or if tailgate 6 can no longer be detected by the camera device or only in distorted form. In this context, a threshold value for the determination that a distortion is present is a function preferably of the light conditions, so that different threshold values are stored for good and bad ambient light (day/night). In addition, it is also possible to activate windshield wiper 19 and/or spray nozzles 25 if a reverse gear is engaged using a gear shift that is not depicted in FIG. 1. Spray nozzles 25 in particular can be arranged in the vicinity of the camera device so that, in response to a specifiable dosing, cleaning fluid is applied to rear window 2 such that the area within the field of vision of the camera is cleaned even without the motion of windshield wiper 19. As a result of the cleaning fluid, which is preferably applied in a small, measured amount on the surface of rear window 2 in front of the camera device, an optical representation is not distorted due to the closeness of the camera to the rear window. In a first exemplary embodiment, a one-time cleaning of the rear window is carried out. Multiple cleanings within a short time are advantageously suppressed, e.g., during a parking procedure, in which there is multiple shifting between forward and reverse gears. For this purpose, a time-controlled squelch circuit is provided, which blocks the cleaning at least for a preestablished time, e.g., for two minutes. Only after the elapsing of this time is there once again an automatic activation of the cleaning in response to a renewed engagement of the reverse gear or a renewed activation of the camera device. In one further exemplary embodiment, it is possible to couple a renewed cleaning to a preestablished velocity value of the vehicle, e.g., 30 km/h, which is achieved only after the termination of a parking procedure. Thus a cleaning is only automatically activated once again if, between the first triggering and a renewed triggering, either the preestablished velocity value of the vehicle has been exceeded, or a drive of the vehicle has been switched off. In this context, the preestablished velocity value should be selected so that it lies just above the vehicle velocities that usually occur in parking procedures.

Third brake light 12 is preferably mounted on rear window 2 by adhesive. In addition, it is also possible to execute lines 16 in a rigid fashion, or to integrate lines 16 in a rigid carrier, and therefore to secure third brake light 12 on vehicle roof 14 via lines 16 or the rigid carrier. As a result of the use of two cameras 17, 18, a stereoscopic image evaluation is possible using an evaluation unit, by superimposing the detected images and calculating the image offset, so that distances to objects jointly detected by first and second cameras 17, 18 can be displayed to a user in display unit 5. In one preferred exemplary embodiment, first and second cameras 17, 18 are executed as video cameras and they transmit a moving image of the driving space. In addition, it is also possible to transmit still pictures in rapid succession.

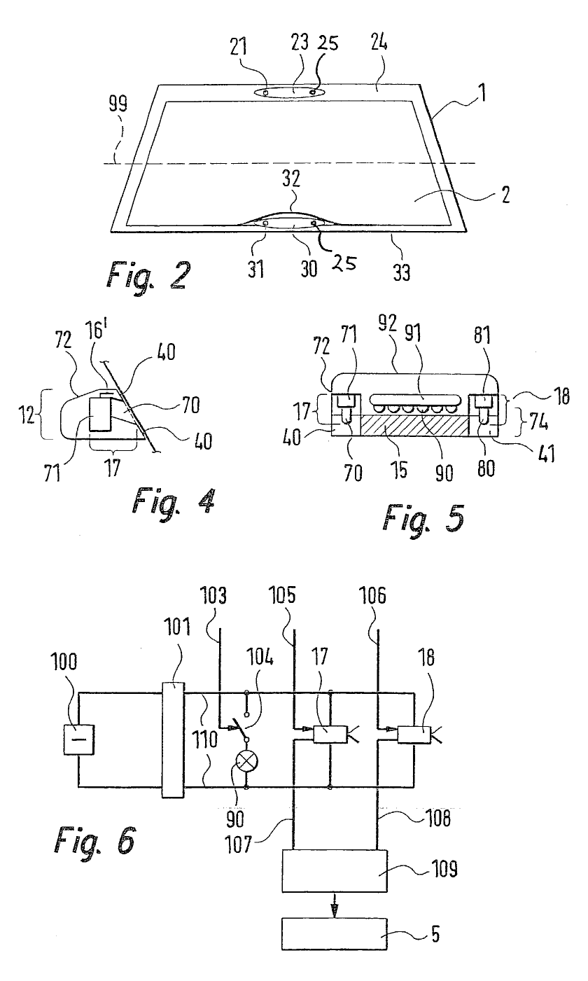

Represented in FIG. 2 are two alternative arrangement possibilities for a third brake light in an upper and lower half of rear window 2 of motor vehicle 1, separated by a dotted line 99. In a first exemplary embodiment, a third brake light 23 along with a camera device 21 is arranged in an upper edge 24, e.g., of a tailgate of motor vehicle 1, which adjoins rear window 2 (above dotted line 99). It is also possible to arrange a third brake light 30 along with a camera device 31 within a convex formation 32 of a lower edge 33 of rear window 2 (beneath dotted line 99). In the arrangement depicted in FIG. 2, third brake light 23, 30 does not have to be arranged behind rear window 2. Therefore, a surface shape of third brake light 23 is not dictated by the surface of rear window 2. However, third brake light 23, 30 can be arranged behind rear window 2, but it does not have to be contacted by the latter. In one preferred exemplary embodiment, a spray nozzle 25 is integrated in a housing of third brake light 23, 30 in order to apply a cleaning fluid. In this manner, a cleaning can be carried out in a way that is spatially close to camera device 21, 31, so that only a small amount of the fluid has to be used. In one exemplary embodiment not depicted in the drawing, the windshield wiper is arranged along with brake light 21, 31.

Depicted in FIG. 3a is a third brake light 12 along with a first camera 17 and a second camera 18. First camera 17 is arranged in a first edge area 40 and second camera 18 in a second edge area 41 of third brake light 12. Edge areas 40, 41 are arranged on opposite sides of luminous surface 15. Edge areas 40, 41 are preferably executed in black and cover first and second cameras 17, 18 up to the visible lens, which barely contrasts against edge areas 40, 41 as a result of the black coloration of edge areas 40, 41. The luminous surface is preferably executed as a red-colored, light-dispersing plastic disk.

Depicted in FIG. 3b is an arrangement possibility of a camera device 50 in a convex formation 52 of a housing of a third brake light 53 having a luminous surface 51. Third brake light 53 is expanded by convex formation 52 on a side facing downwards away from vehicle roof 14 and supports camera device 50. Convex formation 52 is also preferably colored black.

In FIG. 3c, a camera device 60 is arranged on a third brake light 59 behind a luminous surface 61. Camera device 60 observes the rear driving space through luminous surface 61. At least in the area of camera device 60, luminous surface 61 should not be executed in a light-dispersing manner, to avoid influencing through light dispersion the image to be depicted in display unit 5. If an image representation in display unit 5 is black-and-white, no influencing can occur as a result of a coloration of luminous surface 61.

In FIG. 4, a section is depicted in a side view of third brake light 12 in FIG. 3a along dotted line I-II. Arranged on rear window 2 is first camera 17, composed of a lens 70 and an evaluation device 71. Evaluation device 71 and lens 70 are located in a housing 72. Evaluation device 71 is connected to lines 16′, which are conveyed as part of lines 16 from housing 72 to display unit 5. Housing 72 is preferably made of a plastic material and supports first camera 17 having lens 70 and evaluation device 71. In one preferred exemplary embodiment, lens 70 is oriented downwards toward roadway 22, to assure the monitoring of the driving space close to the vehicle. Lens 70 is preferably executed as a wide-angle lens. Evaluation device 71 makes possible an electronic detection of the image produced by lens 70, preferably using a CCD chip or a CMOS chip. In this context, it is possible, in place of visible light, to detect light in the infrared range using the evaluation unit, thus making it possible to observe the rear driving space at night and in fog. In one preferred exemplary embodiment, the transformation of light into an electrical signal is carried out using a nonlinear transformation characteristic, as a result of which one voltage is assigned to one brightness. Using a so-called high-dynamic camera of this type, it is possible to adjust an image brightness even in response to powerful fluctuations in brightness. A luminous surface as well as the illumination means of the third brake light are not depicted in FIG. 4. Edge area 40, into which lens 70 is fit, is beveled and adjusted to rear window 2, so that housing 72 of third brake light 12 is joined flush to rear window 2. In one preferred exemplary embodiment, housing 72 is glued to rear window 2 via edge area 40.

Depicted in FIG. 5 is a longitudinal section of third brake 40 light 12 in a top view along dotted line III-IV in FIG. 3a. A beveled area 74 of third brake light 12 is adjusted to the shape of rear window 2. First camera 17 and second camera 18 are arranged on opposite sides of luminous surface 15. In addition to evaluation device 71 and lens 70 of first camera 17, a lens 80 and an evaluation device 81 of second camera 18 are also depicted. Arranged behind luminous surface 15 is a matrix of LEDs 90. The matrix of LEDs 90 is mounted on a conductive plate 91, using which a voltage measurement is carried out. As a result of a cover 92, which can be removed from housing 72 of third brake light 12, an exchange of the components in third brake light 12 is possible. In place of the matrix of LEDs 90, the use of a neon discharge light source is also possible.

In FIG. 6, a circuit diagram of third brake light 12 is depicted. From a generator 100, e.g., the vehicle battery, a DC voltage is conveyed to a voltage transducer 101. An output voltage of voltage transducer 101 is conveyed in a parallel circuit via supply lines 110 to the matrix of LEDs 90, to first camera 17, and to second camera 18. The current supply of the matrix of LEDs 90 is controlled by a first control line 103, which acts upon a switch 104 that is preferably arranged in housing 72 of third brake light 12. Via a second control line 105, first camera 17 can be activated, and via a third control line 106, second camera 18 can be activated. Via a first evaluation line 107 and via a second evaluation line 108, an output signal of first and/or second camera 17, 18 can be conveyed to evaluation unit 109. The detected image signals for a representation in display unit 5 are prepared in evaluation unit 109. In particular, if both cameras 17, 18 are active, then in one preferred exemplary embodiment a stereoscopic image evaluation is carried out, in which, e.g., the distance to individual obstacles detected by the cameras is represented in display unit 5. Display unit 5 is preferably executed as a liquid crystal display and is preferably arranged in a center console of the vehicle. It can also be arranged in front of a driver in the vehicle. Evaluation unit 109 is located preferably in a dashboard of motor vehicle 1 and is not visible to a passenger in motor vehicle 1. The lines, i.e., power supply lines 110, control lines 103, 105, 106, and evaluation lines 107, 108 are laid through vehicle roof 14 and are also not visible to a passenger in motor vehicle 1. A voltage supply of the matrix of LEDs 90, first camera 17, and second camera 18 is carried out preferably by same supply lines 110. Voltage transducer 101 is preferably arranged in vehicle roof 14 and transforms the voltage delivered from generator 100 preferably first to an AC voltage, then to a lower voltage, and then back into a DC voltage. In this way, it is possible to use a voltage transducer 101, which preferably generates a DC voltage within a range of between 4 and 8 V, both for supplying power to the matrix of LEDs 90 as well as to first camera 17 and second camera 18.

What is claimed is:

1. A camera device for monitoring the rear driving space of a vehicle, at least three brake lights (10, 10′, 12, 23, 30, 53, 59) being arranged on the vehicle (1), the third brake light (12, 23, 30, 52, 59) having a greater distance to a roadway (22) of the vehicle (1) than the first and the second brake lights (10, 10′), the camera device (17, 18, 21, 31, 50, 60) being arranged on the third brake light (12, 23, 30, 53, 59), the third brake light (12, 23, 30, 53, 59) and the camera device (17, 18, 21, 31, 50, 60) being arranged in the area of a rear window (2) of the vehicle (1), a windshield wiper (19) being arranged on the rear window (2), and one area of the rear window (2) in front of the camera device (17, 18, 21, 31, 50, 60) on the rear window (2) being able to be cleaned by the windshield wiper (19), a spray nozzle (25) for applying cleaning fluid, and/or the windshield wiper (19) for cleaning the rear window in the area of the camera device being able to be automatically triggered.

2. The camera device as recited in claim 1,
wherein the windshield wiper (19) and/or the spray nozzle (25) may be triggered by an engaging of a reverse gear and/or by the activation of the camera device (17, 18, 21, 31, 50, 60).

3. The camera device as recited in one of the preceding claims,
wherein a renewed triggering of the windshield wiper (19) and/or the spray nozzle (25) may be blocked using a suppression device for a preestablished time.

4. The camera device as recited in one of the preceding claims,
wherein the windshield wiper (19) and/or the spray nozzle (25) may be automatically triggered in response to a worsening of the image detected by the camera device (17, 18, 21, 31, 50, 60).

5. A camera device as recited in one of the preceding claims,
wherein a sensor is arranged for measuring the reflection of the brake light on the rear window, and the window wiper may be triggered as a function of the reflection.

6. The camera device as recited in one of the preceding claims,
wherein the third brake light (12, 23, 30, 53, 59) and the camera device (17, 18, 21, 31, 50, 60) are arranged in a housing (72).

7. The camera device as recited in claim 6,
wherein the spray nozzle (25) and/or the windshield wiper is arranged on the housing.

8. The camera device as recited in one of the preceding claims,
wherein the third brake light (12, 23, 30, 53, 59) and the camera device (17, 18, 21, 31, 50, 60) are connected to a common voltage supply (16, 110).

9. The camera device as recited in claim 8,
wherein the operating voltage of the common voltage supply (16, 110) is reduced compared to the system voltage in the vehicle (1) and is preferably stipulated within a range of 4 to 8 V.

10. The camera device as recited one of the preceding claims,
wherein an image detected by the camera device (17, 18, 21, 31, 50, 60) may be displayed in a display unit (5) in the vehicle (1) preferably to the driver.

11. The camera device as recited in one of the preceding claims,
wherein a second camera device (18) is arranged on the third brake light (12), image signals recorded by the first and the second camera device (17, 18) may be supplied to an evaluation unit (109), and a stereoscopic image evaluation of the images detected by the first and the second camera devices (17, 18) may be carried out by the evaluation unit (109).

12. The camera device as recited in one of the preceding claims,
wherein the camera device (17, 18, 21, 31, 50, 60) is a CCD camera and/or a CMOS camera.

13. The camera device as recited in one the preceding claims,
wherein the transformation characteristic curve of the camera device (17, 18, 21, 31, 50, 60) is a nonlinear transformation characteristic curve, and a rise in the transformation characteristic curve is diminished as incident light increases.

14. A brake light for a vehicle, it being possible to arrange the brake light on the rear window of the vehicle,
wherein a camera device (17, 18, 21, 31, 50, 60) as recited in one of the preceding claims may be mounted in the brake light (12, 23, 30, 53, 59).
